(19) United States
(12) Patent Application Publication
(10) Pub. No.: US 2024/0017332 A1
(43) Pub. Date: Jan. 18, 2024

(54) MECHANISM FOR OPTIMISING A MANUAL ANGULAR ADJUSTMENT

(71) Applicant: Seco Tools Tooling Systems, Bouxwiller (FR)

(72) Inventors: Claude JAEGER, Monswiller (FR); Sebastien HOPFNER, Thal Marmoutier (FR)

(21) Appl. No.: 16/769,975

(22) PCT Filed: Nov. 30, 2018
(86) PCT No.: PCT/EP2018/083223

§ 371 Date: Apr. 13, 2023

(30) Foreign Application Priority Data
Dec. 5, 2017 (FR) 1761662

(51) Int. Cl. B23B 29/034

(52) U.S. Cl. CPC B23B 29/034; B23B 2260/038; B23B 2260/088

(57) ABSTRACT

A mechanism for the optimisation of a manual angular adjustment.

The object of this invention concerns an assembly including:
A fixed mount (1);
A part (2) having at least one approximately circular face mounted on the fixed mount (1) so that the part (2) is mounted so as to be mobile in rotation around an axis approximately centred on the circular

characterised in that the assembly also includes a device for the positional adjustment of the part in relation to the mount including at least:
One first scale (4) in an area (5) linked to the fixed mount (1) positioned on at least one portion of the periphery of the mobile part (2), the first scale (4) being a measuring scale;
One second scale (6) positioned on the circular face of the mobile part (2), the second scale (6) being a Vernier scale.

### DESCRIPTION

This invention concerns the field of manual adjustment mechanisms and more specifically the field of mechanisms for the optimisation of manual angular adjustment.

Currently, when adjusting a part mounted pivotingly that is approximately axially symmetrical around its rotational axis, it is customary to position a standard scale on a part of its surface located opposite the surface of a fixed part in relation to which the part is pivoting. This standard scale allows a handler to adjust the angular position of the pivoting part in relation to a reference, generally taking the material form of a mark present on the surface of a fixed area in relation to which the part is pivoting.

As an improvement, the marking used as a reference on the surface of a fixed area is made in the form of a Vernier scale. This arrangement thereby allows one to optimise the manual angular adjustment of the pivoting part in relation to the structure of the fixed housing. Adjustment is then carried out in a manner similar to that employed for a goniometer.

However, for such a mechanism to remain functional for manual adjustment by a user, it is essential that the surface of the pivoting part bearing the markings of a standard scale should be sufficiently large to be legible by the user. Indeed, for parts of a restricted diameter such as precision adjustment screws, the scale marking is of a reduced size and the quality of legibility affects the quality of adjustment by the user. Where a standard scale is used in combination with a Vernier scale, this also affects the benefits of Vernier adjustment as the reading of the standard scale is altered.

The purpose of this invention is to offset this disadvantage by supplying an easy-to-use mechanism that facilitates the manual angular adjustment of a pivoting part in relation to a fixed structure while optimising user legibility of the marking that contributes to this adjustment.

The object of the invention is therefore an assembly including:
A fixed mount;
A part having at least one approximately circular face mounted on the fixed mount so that the part is mounted to be mobile in rotation around an axis approximately centred on the circular face;
   characterised in that the assembly also includes a device to align the position of the part in relation to the mount including at least:
A first scale on a surface linked to the fixed mount and positioned on at least a portion of the periphery of the mobile part, the first scale being a measuring scale;
A second scale positioned on the circular face of the mobile part, the second scale being a Vernier scale.

The invention also concerns a cutting or boring device characterised in that the device includes at least one assembly according to the invention.

The invention also concerns a micrometer cartridge characterised in that the cartridge includes at least one assembly according to the invention.

The invention concerns a boring bar characterised in that the bar includes at least one assembly according to the invention.

The invention will be better understood thanks to the description below, which relates to a preferred embodiment, provided as a non-exclusive example, and explained with reference to the schematic drawings appended in which:

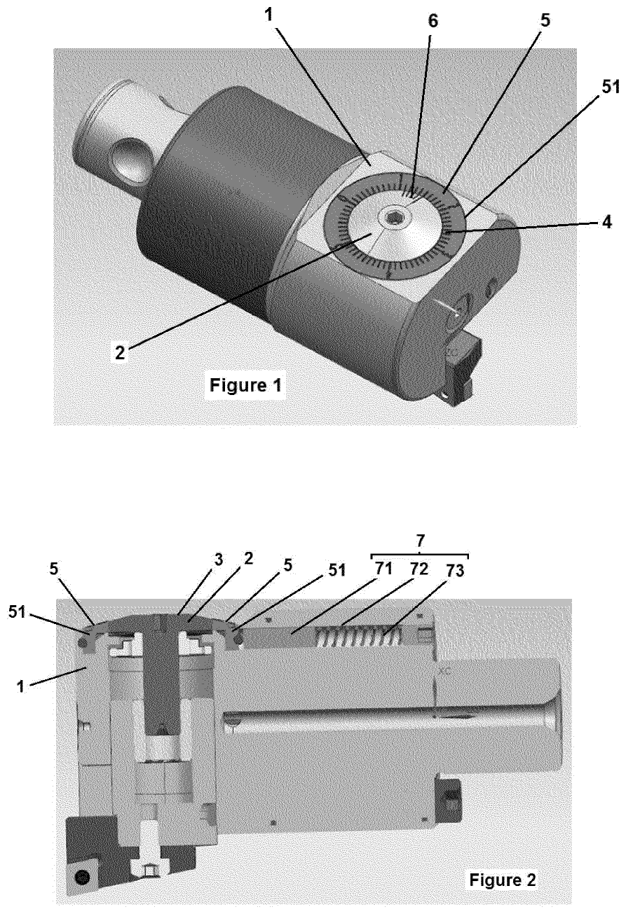

FIG. 1 is a schematic depiction of an example of an assembly constructed according to the invention;

FIG. 2 is a sectional schematic depiction of an example of an assembly constructed according to the invention.

It should be noted that, in this document, the terms “mobile” and “fixed” relate, respectively, to the pivoting part 2 and to the mount 1 that holds the pivoting part 2 in relation to which the pivoting part 2 is adjusted angularly. The terms must essentially be understood as allowing one to define only the relationship between the pivoting part 2 and the mount 1. Thus, it is necessary to note that there is no limitation under the invention that is liable to prevent the mount 1 being immobile in relation to a third structure.

The object of the invention is therefore an assembly including:
A fixed mount 1;
A part 2 having at least one face 3 that is approximately circular and mounted on the fixed mount 1 so that the part 2 is mounted to be mobile in rotation around an axis approximately centred on the circular face 3;
   characterised in that the assembly also includes a device to adjust the position of the part in relation to the mount, including at least:
A first scale 4 on a surface 5 linked to the fixed mount 1 and positioned on at least one portion of the periphery of the mobile part 2, the first scale 4 being a measuring scale;
A second scale 6 positioned on the circular face 3 of the mobile part 2, the second scale 6 being a Vernier scale.

The assembly under the invention positions the measuring scale, namely the first scale 4, on a surface 5 associated with the fixed mount 1. The size of the measuring scale 4 is generally larger than that of a Vernier scale 6. Thus, the positioning of the measuring scale 4 in an area 5 linked to the fixed mount 1 allows advantage to be taken of the greater scope for the mount 1 to bear the measuring scale 4 compared to the area available on the circular face 3 of the mobile part 2.

Under these conditions, the measuring scale provides a larger area for markings and therefore its legibility and the identification of measurements sought by a user are optimised for angular adjustment of the mobile part 2.

Additionally, the Vernier scale is transferred onto at least one portion of the circular face 3 of the mobile part 2. As the size of a Vernier scale 6 is generally smaller than that of a measuring scale 4, the size of the area needed to bear the markings is therefore reduced.

According to a preferred embodiment, the first scale 4, corresponding to the measuring scale 4, is positioned in an area 5 linked to the fixed mount 1, on an edge surrounding at least a section of the circular face 3 of the mobile part 2.

According to one non-exclusive construction feature of the invention, this edge of the area 5 linked to the fixed mount 1 that extends along at least one section of the circular face 3 of the mobile part 2 is in contact and/or in the immediate proximity of the peripheral edge of the mobile part 2.

According to an additional preferred embodiment, the second scale 6, corresponding to the Vernier scale 6, is positioned on at least one section of the peripheral edge of the circular face 3 of the mobile part 2. This positioning thereby allows for the optimal legibility of the angular measurement with the first (measuring) scale 4, marked in relation to the circular face 3 of the mobile part 2.

The angular position of the mobile part 2 in relation to the area 5 associated with the fixed mount 1 is established by reading the correspondence between at least two marks taken as references from the second, Vernier scale 6, on the one hand, and at least two marks located on the first, measuring scale 4, on the other.

According to one particular embodiment of the assembly under the invention, the area 5 linked to the mount 1 bearing the first scale 4 is fixed to the mount 1 so that the first scale 4 is not adjustable vis-a-vis the mobile part 2. According to this embodiment, the first scale 4 is fixed so that when the mobile part 2 is displaced angularly, the adjustment of the size of the displacement requires one, firstly, to determine the starting position of the mobile part 2 and then, secondly, to calculate the end-of-travel position desired so as to regulate the adjustment of this end-of-travel position depending on the size of the displacement sought.

According to one particular embodiment of the assembly under the invention that is an alternative to the particular embodiment above, the area 5 linked to the mount 1 bearing the first scale 4 constitutes a second part 51 mounted to be mobile in rotation in relation to the mount 1, around a swivel pin shared with the swivel pin of the mobile part 2. According to this embodiment, the first scale 4 includes at least one mark corresponding to a reference value that is adjustable vis-a-vis a mark from the second scale 6 of the mobile part 2 in an immobile position. Thus, according to this embodiment, the first scale 4 is adjustable to the mobile part 2, so that during angular displacement of the mobile part 2, the adjustment of the size of the displacement consists, firstly, in positioning at least one mark from the first measuring scale 4 corresponding to a reference value vis-a-vis a mark from the second Vernier scale 6 of the mobile part 2. This adjustment is made by pivoting the second part 51 mounted to be mobile in rotation in relation to the mount 1 while the mobile part 2 that bears the second Vernier scale 6 is kept immobile. Secondly, the mark from the second Vernier scale 6 of the mobile part 2 is displaced to the extent desired along the first measuring scale 4 to an end-of-travel position corresponding to the desired angular displacement of the mobile part 2.

According to one feature of this particular embodiment of the assembly under the invention, the area 5 bearing the first scale 4 takes the form of a circular ring 51 centred on the swivel pin of the mobile part 2 bearing the second scale 6. According to one example of the implementation of this construction feature, the inner edge of the circular ring 51 is positioned in proximity to and/or in contact with the peripheral edge of the circular face 3 of the mobile part 2; the circular ring 51 and the mobile part 2 bearing the second scale 6 being concentric and mobile around a single swivel pin.

According to another construction feature of the assembly under the invention that complements the different features detailed, at least one part 2, 51 mounted to be mobile in rotation in relation to the mount 1 is combined with a braking mechanism 7 for the rotation of the mobile part 2 , 51. According to one construction example, this braking mechanism 7 comprises a contact part 71 mounted so as to slide along a displacement and pressurizing guide 72 operated by means of a spring 73 so that the contact part 71 rests against an edge, preferably peripheral, of the mobile part 2, 51 to be braked. This braking mechanism 7 combined with a part 2, 51 that intervenes, directly or indirectly, in the manual adjustment, allows the mobility of the mobile part 2, 51 concerned to be retained, while limiting or even preventing parasitic or unwanted angular displacements. This braking mechanism 7 also allows the mobile part concerned 2, 51 to be held when the user is not handling it.

According to another alternative or complementary construction feature of the assembly under the invention, at least one part 2, 51 mounted to be mobile in rotation in relation to the mount 1 is combined with an incrementation mechanism.

According to one complementary feature of the invention, the mobile part 2 bearing the second Vernier scale 6 comprises a screw, for example a screw forming part of a clamping device.

The invention also concerns a cutting or boring device characterised in that the device includes at least one assembly according to the invention.

More specifically, the invention also concerns a micrometer cartridge characterised in that the cartridge includes at least one assembly according to the invention.

In addition, the invention concerns a boring bar characterised in that the bar includes at least one assembly according to the invention.

Clearly, the invention is not limited to the embodiments described and depicted in the drawings appended. Modifications remain possible, particularly as regards the constitution of the various items or through the substitution of equivalent techniques, without thereby departing from the scope of protection of the invention.

1. An assembly comprising:
a fixed mount;
a mobile part having at least one approximately circular face mounted on the fixed mount so that the part is mounted so as to be mobile in rotation around an axis approximately centred on the circular face;
a device arranged for the positional adjustment of the mobile part in relation to the mount, the device including at least one first scale located in an area linked to the fixed mount and positioned on at least one portion of the periphery of the mobile part, the first scale being a measuring scale, and at least one second scale positioned on the circular face of the mobile part the second scale being a Vernier scale, wherein the area associated with the mount bearing the first scale constitutes a second part mounted so as to be mobile in rotation in relation to the mount, around a swivel pin shared with a swivel pin of the mobile part.

2. The assembly according to claim 1, wherein the at least one first scale includes at least one mark corresponding to a reference value that is adjustable vis-à-vis a mark on the second scale of the mobile part in an immobile position.

3. The assembly according to claim 1, wherein the area bearing the at least one first scale takes the form of a circular ring centered on a swivel pin of the mobile part bearing the at least one second scale.

4. The assembly according to claim 1, wherein at least the mobile part or another part mounted so as to be mobile in rotation in relation to the mount is combined with a braking mechanism for the rotation of the mobile part.

5. The assembly according to claim 1, wherein at least the mobile part or another part mounted so as to be mobile in rotation in relation to the mount is combined with an incrementation mechanism.

6. A cutting or boring device comprising at least one assembly according claim 1.

7. A micrometer cartridge comprising at least one assembly according claim 1.

8. A boring bar comprising at least one assembly according claim 1.
